(19) United States
(12) Patent Application Publication
(10) Pub. No.: US 2012/0072943 A1
(43) Pub. Date: Mar. 22, 2012

(54) Delivering Advertisements Based on Electronic Coupons Transmitted from a Digital Television System to a Mobile Communication Device

(76) Inventor: Yang Pan, Singapore (SG)

(21) Appl. No.: 12/885,414

(22) Filed: Sep. 17, 2010

(51) Int. Cl. H04N 7/16

(52) U.S. Cl. 725/23

(57) ABSTRACT

A system for delivering advertisements based on a digital television system and a mobile communication device is disclosed. The television system and the mobile device are connectable in an ad hoc manner. When a user is attracted by an advertisement being broadcasted by the television, an instruction may be sent from a remote control device of the television system to trigger the television system to send an electronic coupon to the mobile device. An icon may then be displayed on a display screen of the mobile device to represent the coupon. When the icon is selected, the electronic coupon is displayed. The electronic coupon may include an advertising message. The user may select the message for receiving detailed information about the product from a data manager connected to the mobile device through a communication network.

### CROSS-REFERENCE TO RELATED APPLICATIONS

Not applicable.

### BACKGROUND

1. Field of Invention

This invention relates generally to advertising. More specifically, the invention relates to system and method for delivering advertisements to a mobile communication device.

2. Description of Prior Art

Advertising using television is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste.

Mobile communication devices have gained significant popularity in recent years. Users are using the mobile device such as, for example, iPhone from Apple Inc, Cupertino, Calif., to access the Internet services. Methods for delivering targeted advertisements to users by employing mobile communication devices have been developed. The targeted advertising messages may be delivered based upon the user's personal profile, location and history of the user's interaction with the device.

Even when sometimes the advertisements broadcasted by the television are attracted by a viewer, the information provided by the television is often insufficient for the viewer to make a purchasing related decision.

The adoption of digital television system has opened up new opportunities to deliver advertisements to targeted customers. The opportunities, however, have not been fully explored, in particularly, when the digital television system and the mobile communication are combined.

### SUMMARY OF THE INVENTION

It is an object of the present invention to propose a method for delivering an electronic coupon, related to an advertising message being broadcasted, from a digital television system to a mobile communication device.

It is another object of the present invention to propose a method for delivering an electronic coupon, including an advertising message, from a digital television system to a mobile communication device

It is yet a further object of the present invention to propose a method for delivering an electronic coupon to a mobile communication device based on a user's reaction to a randomly displayed message during broadcasting of an advertising message in the digital television system.

In accordance with one embodiment of the present invention, the digital television (TV) system is used to deliver media assets to a user. Advertisements may be delivered to the user based on a predetermined schedule. The digital TV system may be connected to a mobile communication device through an ad hoc communication link such as through a Bluetooth type of connection. If the user is interested in the advertisement being broadcasted, he may use a remote control device to send a control signal to the TV system. An electronic coupon related to the advertisement being broadcasted may then delivered to the mobile communication device.

The received electronic coupon may be displayed as a representative icon on a display of the mobile device. Upon the user's selection of the icon, an image of the electronic coupon is displayed. The displayed coupon may include coupon related messages such as, for example, the value of the coupon and the expiring date of the coupon. The displayed coupon may also include an advertising message. The advertising message may comprise text, pictures, photographs, web sites and video programs.

The mobile communication device may be connected to a communication network such as the Internet. A data manager may be connected to the mobile device through the communication network. The user may select the advertising message displayed on the coupon for the next level of details. The detailed messages may be delivered from the data manager.

In accordance with another embodiment, an alerting message is displayed in a randomly selected time during broadcasting of the advertisement by the digital television system. An electronic coupon is delivered to the mobile device only if the user actuates the remote control device within a predetermined period of time of the displaying of the alerting message. The electronic coupon becomes a reward for the user's action of viewing of the advertisement. The coupon may include an advertising message.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an advertisement delivery system based on a digital TV system and a mobile communication device in accordance with one embodiment;

FIG. 2A is a schematic diagram of functional blocks and data flow of the system in accordance with one embodiment;

FIG. 2B is a schematic diagram of functional blocks and data flow of the system in accordance with another embodiment;

FIG. 3 is a schematic diagram illustrating an icon is displayed on a screen of a mobile device as a representative of the received electronic coupon;

FIG. 4A is a schematic diagram of functional blocks of the digital TV system in accordance with one implementation;

FIG. 4B is a schematic diagram of functional blocks of the mobile communication device in accordance with one implementation;

FIG. 5 is a flowchart illustrating an exemplary process that an electronic coupon is delivered from the digital television system to the mobile device.

FIG. 6 is a flowchart illustrating an exemplary process that an electronic coupon is used to deliver advertising messages;

FIG. 7 is a flowchart illustrating an exemplary process that an electronic coupon is delivered from the digital television system to the mobile device based on the user's reaction to a randomly displayed alerting message during broadcasting of an advertisement.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

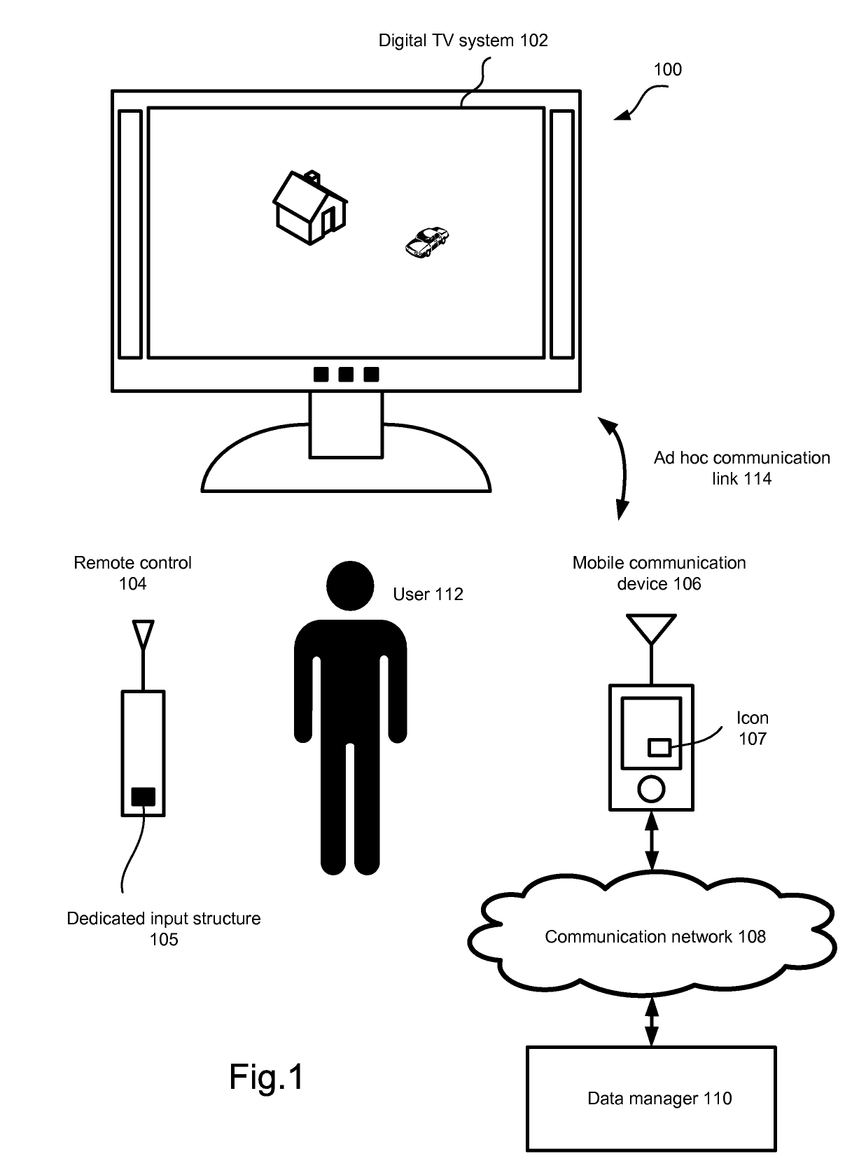

FIG. 1 is a schematic diagram illustrating an advertisement delivery system according to one embodiment. The system 100 comprises a digital TV system 102 with a remote control device 104. The remote control device 104 may include a dedicated input structure 105 for controlling of transmitting of an electronic coupon including an advertising message from the TV system 102 to the mobile communication device 106. The input structure 105 may be a button, a touch pad or an icon in a touch-sensitive display. The mobile communication device 106 may be a mobile phone with the Internet connection capability. The mobile device 106 is connectable to a data manger 110 through the Internet 108 in an exemplary implementation. The mobile communication device 106 may include an icon representing the received electronic coupon. A user 112 operates the system. The remote control device 104 and the digital TV system 102 are connected employing one of well known methods such as, for example, using the Infrared communication interface. The digital TV system 102 and the mobile device 106 may be connected using an ad hoc communication link 114. The ad hoc communication link 114 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC).

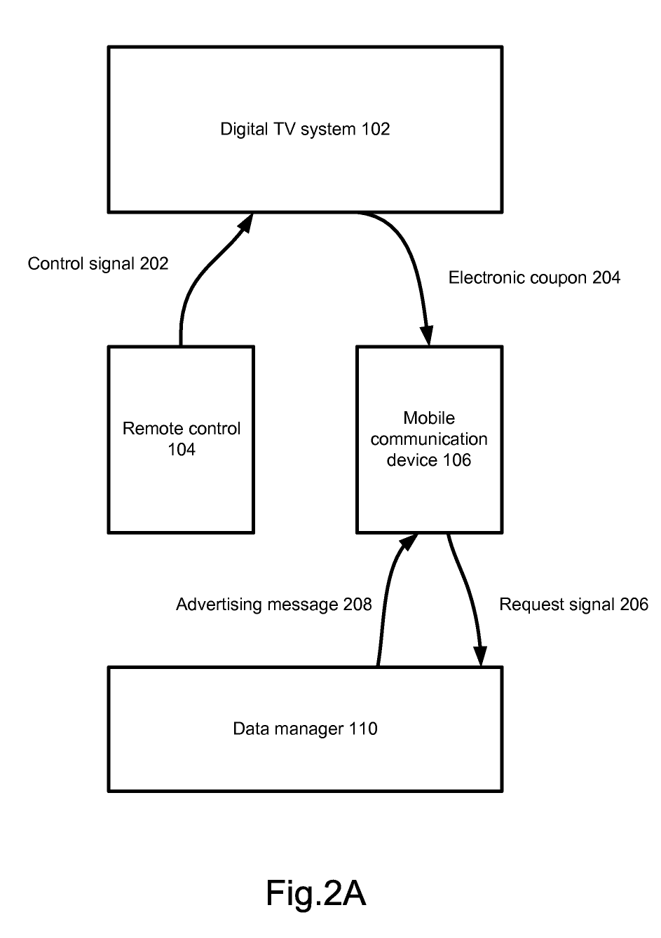

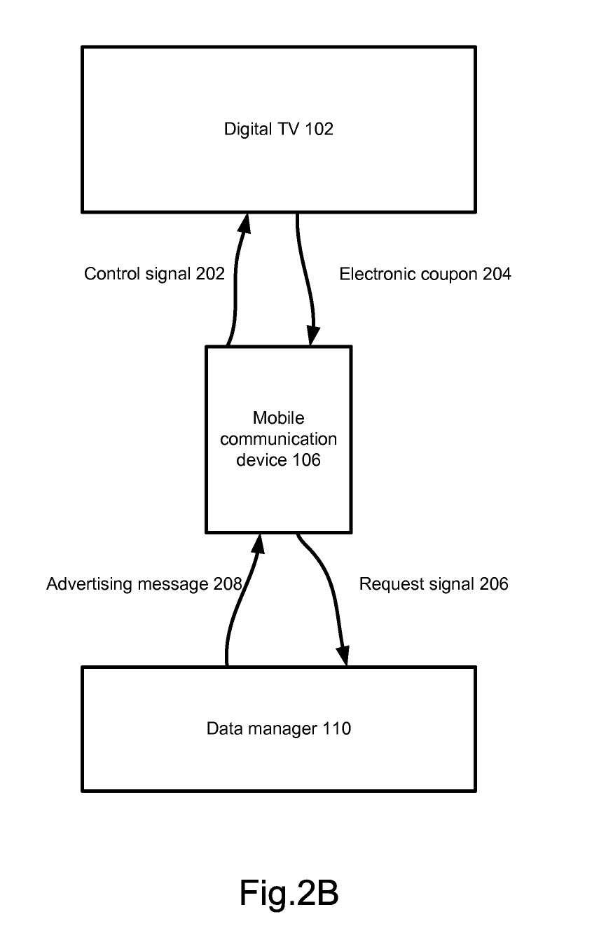

FIG. 2A is a schematic diagram of functional blocks and data flow of the system 100 in accordance with one embodiment. When a digital TV system 102 is used to broadcast a program, advertisements may be inserted and be broadcasted based on a predetermined schedule. When a specific advertisement is broadcasted, an electronic coupon may be stored temporally in a buffer of the TV system 102 as a data file 204. The coupon may be related to the advertisement. If the user is attracted by the advertisement and wants to know more about the product, he may use the remote control device 104 to send a control signal 202 to the digital TV system 102. After receiving the control signal 202, the digital TV system 102 will send the electronic coupon 204 to the mobile device 106. The electronic coupon 204 may be represented by an icon displayed on a display screen of the mobile device 106. If the icon is selected by the user 112, a request signal 206 is sent to a data manager 110 through the Internet 108. The data manager 110 sends more detailed product information (advertising messages) to the mobile device 106. The product information 208 may be presented using a web site displayed on the display screen of the mobile device 106. It should be noted that the electronic coupon 204 sent from digital TV system 102 to the mobile device 106 may include an advertising message in various forms. For example, the message may include a text message, an image, a voice message, video clip and a multimedia file related to the advertisement being played. The user may use the mobile device 106 to view the received coupon and the advertising message.

The remote control device 104 may include a dedicated input structure 105 for delivering the control signal 202. The dedicated input structure 105 may be a button, a touch pad, an icon in a touch-sensitive screen or be any other structures as known in the art. When the input structure is actuated, a processor in the remote control 104 receives the signal and sends the control signal to the digital TV system 102.

According to another implementation, one of the existing input structures of the remote control device 104 may be used to display a control menu on the screen of the digital TV system 102. The control menu may include at least one user selectable item. After the user's selection using the remote control device 104, a control signal is generated to trigger the operation of sending the electronic coupon 204 to the mobile device 106.

FIG. 2B is a schematic diagram of functional blocks and data flow of the system 100 in accordance with another embodiment. The mobile communication device 106 is used to send a control signal 202 to the digital TV system 102. If the user is attracted by the advertisement and wants to know more about the product, he may use the mobile device 106 to send a control signal 202 to the digital TV system 102. According to one implementation, an input structure may be actuated to display a control menu on the screen of the mobile device 106. The control menu may include at least one user selectable item. After the user selects the item, a control signal 202 is generated and is sent to the digital TV system 102. The electronic coupon 204 is then sent to the mobile device 106. Similarly, the request signal 206 may be sent to the data manger 112 and the detailed advertising message 208 is sent to the mobile device 106 in a form of web site according to one implementation.

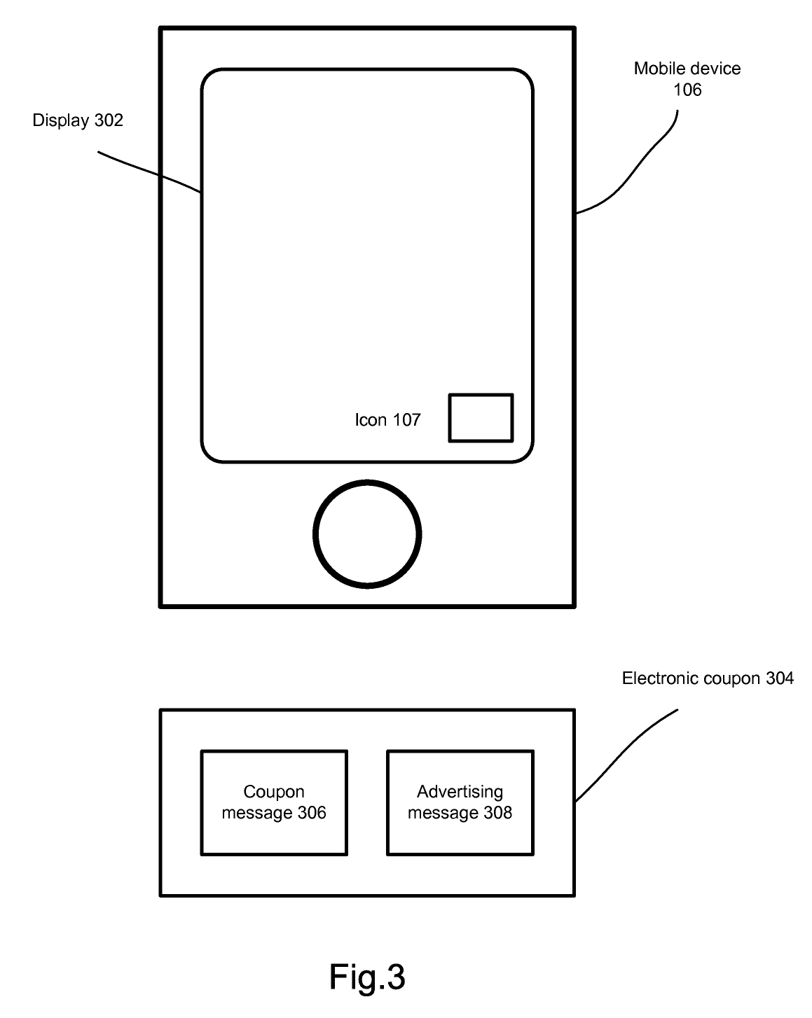

FIG. 3 is a schematic diagram illustrating that an icon 107 is displayed as a representative of the received electronic coupon on the display 302 of the mobile device 106. The icon 107 may be displayed on a gateway screen of the mobile device. The icon 107 may also be displayed on a designated folder of the mobile device 106. An image of the electronic coupon 304 may be displayed upon the user's selection. According to one implementation, the display of the mobile device 106 is a touch-sensitive type of display. The user may use one of his fingers to touch the icon 107 to make the selection. The electronic coupon image 304 may include a portion for displaying coupon related message 306. The electronic coupon image 304 may also include a portion for displaying an advertising message 308 as shown in the figure. The user may select the advertising message for the next level of details.

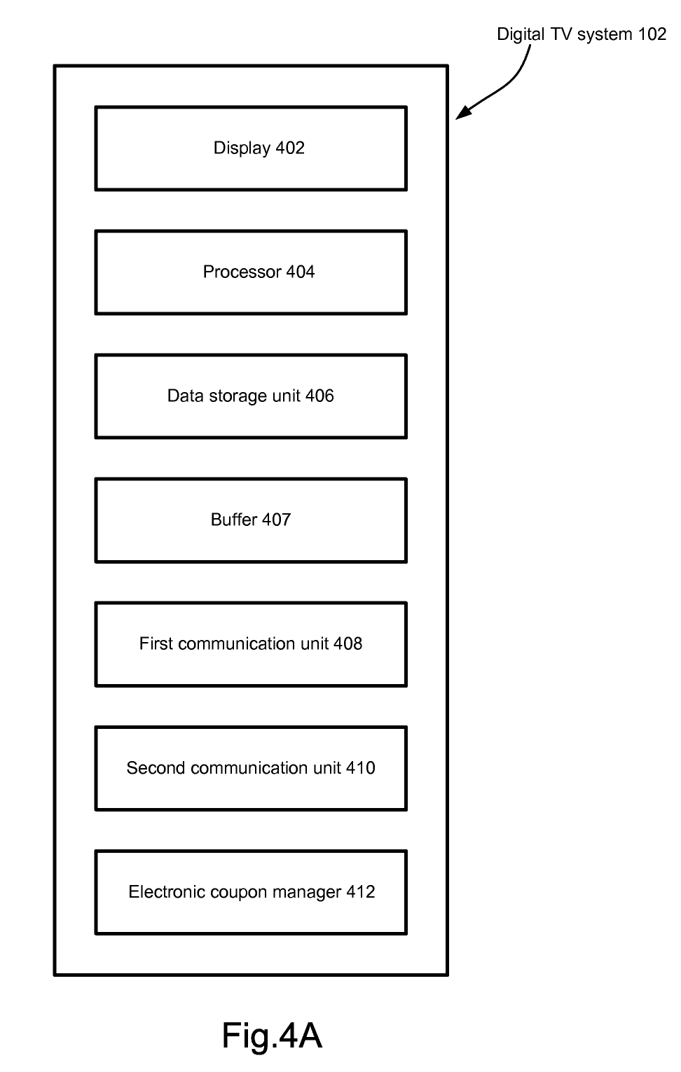

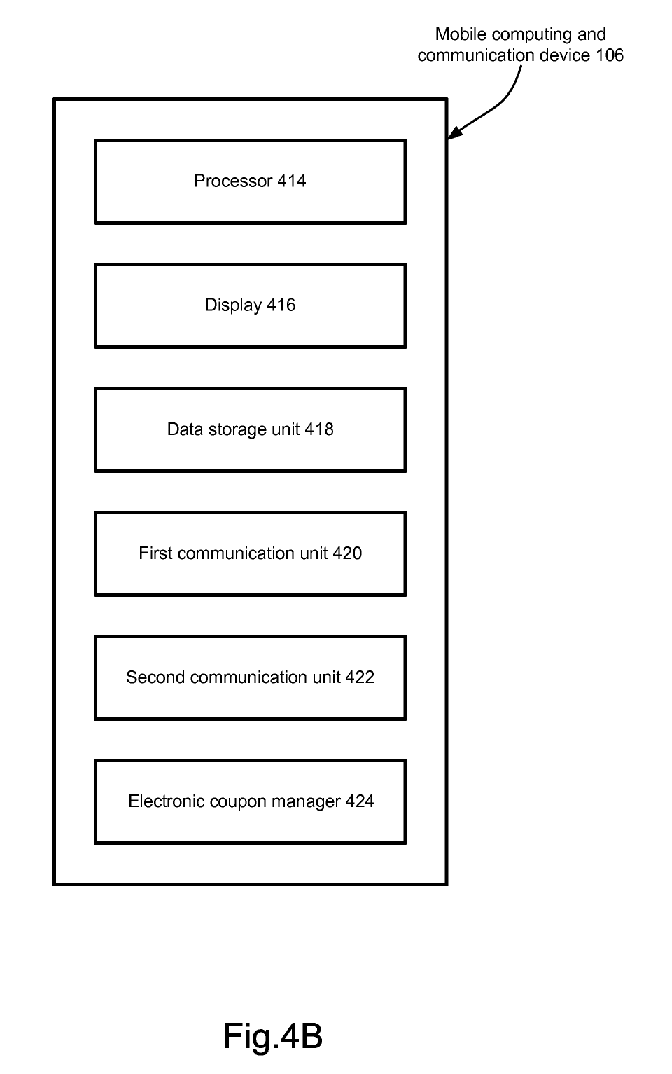

FIG. 4A is a schematic representation of functional blocks of the digital TV system 102 in according with one embodiment. The system 102 comprises a display 402. The display may be a Liquid Crystal Display (LCD). The display may also be any other types of display as known in the art. A processor 404 is used to control the operation of the digital TV system 102. The processor 404 may include more than one type of processors including a general purpose processor such as a Central Processing Unit (CPU) and a special purpose processor such as a Graphical Processing Unit (GPU). The system 102 may also include a data storage unit 406 such as a magnetic storage unit and/or semiconductor memory devices. A buffer 407 is used to provide shorter access time. A buffer may be implemented using Static Random Access Memory (SRAM). When an advertisement is being broadcasted, an electronic coupon may be stored in the buffer temporally.

The digital TV system 102 may be connected to a communication network through a first communication unit 408. The network may be a private broadband network for delivering TV programs. The network may also be a public network such as, for example, the Internet. A second communication unit 410 is used to connect the digital system 102 to the mobile device 106 through an ad hoc communication link 114. The ad hoc communication link 114 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC). The digital TV system 102 may also include a third communication unit (not shown in the figure) for connecting the system and the remote control device 104. Most remote control devices today use Infrared communication interfaces.

An electronic coupon manager 412 may include a function to control the operation of the electronic coupon delivery. It may be implemented as a software program to be executed by the processor 404. It may also be implemented as a combination of the software and the hardware.

FIG. 4B is a schematic representation of functional blocks of the mobile communication device 106. The device 106 comprises a processor 414, a display 416, a data storage unit 418 and a first communication unit 420 as known in the art. The first communication unit 420 may be a standard network interface for a smart phone including a capability to connect to the Internet. The device 106 further comprises a second communication unit 422 for connecting to the digital TV system 102 through the previously mentioned ad hoc communication link 114. An electronic coupon manager 424 may include a function to control the operation of receiving the electronic coupon 204 and the operation of displaying the icon to represent the received electronic coupon in an exemplary implementation.

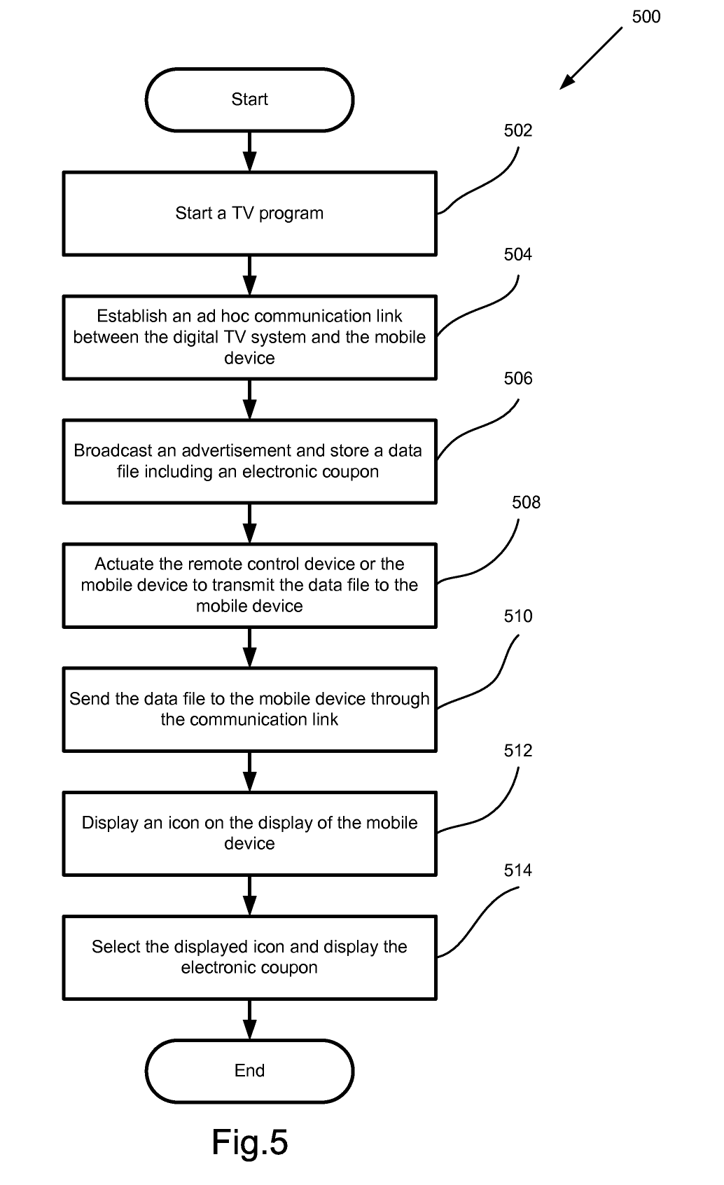

FIG. 5 is a flowchart illustrating a process that the electronic coupon is transmitted from the digital TV system 102 to the mobile device 106. Process 500 begins with starting a TV program in step 502. An ad hoc communication link 114 is established in step 504 between the digital TV system 102 and the mobile device 106. The communication link 114 may be a Bluetooth type of connection in an exemplary implementation. The communication link may also be a NFC including a RF tag in the digital TV system 102 and a reader in the mobile device 106 in another exemplary implementation. In step 506, an advertisement is broadcasted by the digital TV system 102 according to a predetermined schedule. An electronic coupon related to the advertisement may be stored in the buffer 407. In step 508, the remote control device 104 is actuated by the user 112. The user 112 may actuate a dedicated input structure 105 according to one implementation. The user 112 may also actuate a non-dedicated input structure to have a control menu displayed in a selected area of the display screen of the digital system 102 according to another implementation. The user 112 may select a user selectable item. As a result, a control signal is sent to the processor 404 to start an operation of transmitting the electronic coupon. In step 510, the electronic coupon 204 including the advertising message is sent to the mobile device 106 through the ad hoc communication link 114. An icon 107 representing the received electronic coupon is displayed on the display screen of the mobile device 106 in step 512. The icon may be selected by the user in step 514 to display an image of the electronic coupon.

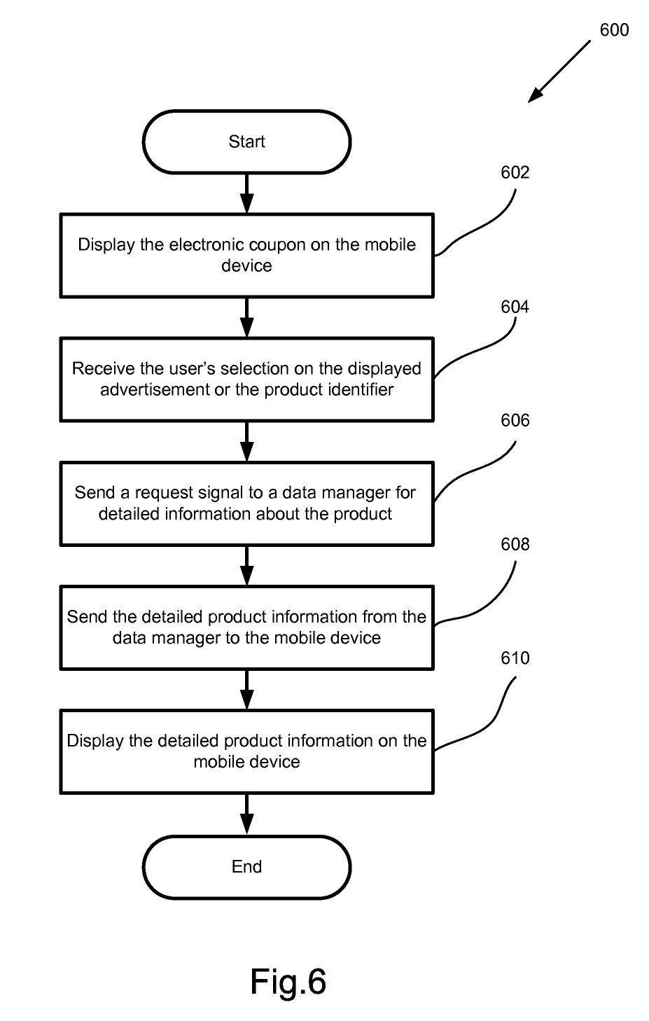

FIG. 6 is a flowchart illustrating a process that detailed product information is sent to the mobile device 106 from the data manager 110 through a communication network such as the Internet 108. Process 600 starts with step 602 that the icon 107 representing the received electronic coupon is displayed on the screen of the mobile device 106. The display may be a touch-sensitive screen according to one implementation. The user may touch the icon 107 in step 604 to request the detailed product information. The mobile device 106 and the data manager 110 are connected through the Internet 108 in step 606. The detailed product information or the advertising message may be sent to the user in step 608 upon the user's request. The data manager 110 may be an operator to provide detailed product information when receiving a request. The data manager 110 may be connected to retailers, advertisers and consumer rating organizations. After they are connected, a web page may be displayed in step 610. The product information or detailed advertising message may be delivered to the user 112 in a hierarchical manner as known in the art. The user may navigate through the user interface and find useful information related to the product. The user may decide to purchase the product through an on-line facility after reviewing the product information.

The user's operation may be tracked and data may be collected and be sent back to the digital TV system 102. The advertisers may be paid based on which electronic coupons are downloaded by the user and also by which products the user purchased through the on-line facility.

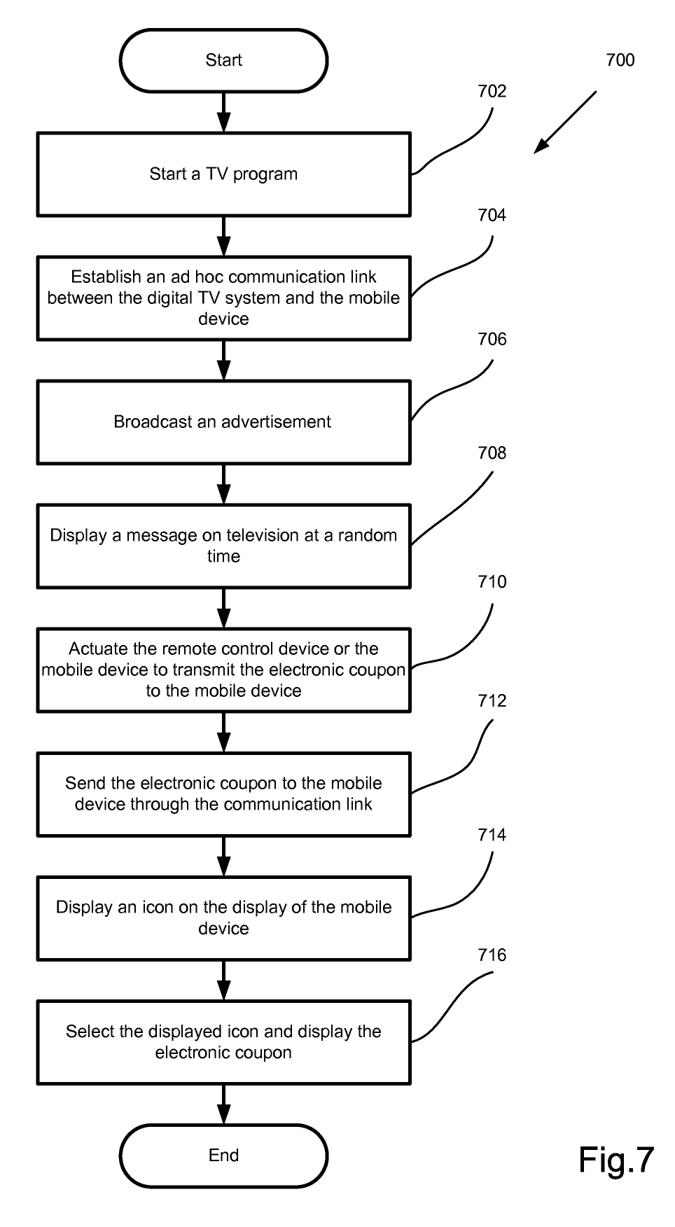

FIG. 7 is a flowchart illustrating a process that the electronic coupon is transmitted from the digital TV system 102 to the mobile device 106 according to another embodiment. Process 700 begins with starting a TV program in step 702. An ad hoc communication link 114 is established in step 704 between the digital TV system 102 and the mobile device 106. The communication link 114 may be a Bluetooth type of connection in an exemplary implementation. The communication link may also be a NFC including a RF tag in the digital TV system 102 and a reader in the mobile device 106 in another exemplary implementation. In step 706, an advertisement is broadcasted by the digital TV system 102 according to a predetermined schedule. An electronic coupon related to the advertisement may be stored in the buffer. In step 708, an alerting message may be displayed on the screen of the digital TV system 102 when the advertisement is broadcasted. The message may be displayed in a randomly determined time. The message may be displayed for a predetermined period of time during the broadcasting of the advertisement. The user, notifying the message, may actuate the remote control device 104 in step 710 to trigger the operation of transmitting the electronic coupon. The user 112 may actuate a dedicated input structure 105 according to one implementation. The user 112 may also actuate a non-dedicated input structure to have a control menu displayed in a selected area of the display screen of the digital system 102 according to another implementation. The user 112 may select a user selectable item. As a result, a control signal is sent to the processor 404 to start an operation of transmitting the electronic coupon. In step 712, the electronic coupon 204 including the advertising message is sent to the mobile device 106 through the ad hoc communication link 114. An icon 107 representing the received electronic coupon is displayed on the display screen of the mobile device 106 in step 714. The icon may be selected by the user in step 716 to display an image of the electronic coupon.

While the invention has been disclosed with respect to a limited number of embodiments, numerous modifications and variations will be appreciated by those skilled in the art. It is intended that all such variations and modifications fall with in the scope of the following claims:

1. An advertisement delivery system comprising:
a digital television system including a remote control device;
a mobile communication device; and
a communication means for transmitting an electronic coupon from the television system to the mobile device,
wherein the electronic coupon including at least one advertisement.

2. The system as recited in claim 1, wherein said electronic coupon may be displayed as an icon after received by the mobile communication device.

3. The system as recited in claim 2, wherein said icon may be selected by a user to display an image of the electronic coupon including at least one advertising message.

4. The system as recited in claim 3, wherein said advertising message may be selected by a user to display next level of details of the message, wherein the next level of details of the message may be transmitted from a data manager connected to the mobile device through a communication network.

5. The system as recited in claim 4, wherein said data manager further providing a means of connecting to one or a plurality of retailers, to one or a plurality of manufacturers, and to one or a plurality of customer rating organizations.

6. The system as recited in claim 1, wherein said digital television system further comprising:
a display screen;
a processor;
a data storage unit;
a first communication unit for connecting to a communication network;
a second communication unit for connecting to the mobile device; and
an electronic coupon manager including a function of transmitting the electronic coupon to the mobile device.

7. The system as recited in claim 1, wherein said mobile communication device further comprising:
a processor;
a display;
a data storage unit;
a first communication unit for connecting to a public communication network;
a second communication unit for connecting to the digital television system; and
an electronic coupon manager including functions of receiving and displaying electronic coupon.

8. The system as recited in claim 1, wherein said communication means conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).

9. A method of delivering an advertising message to a mobile communication device comprising:
establishing an ad hoc communication link between a digital television system and the mobile device;
broadcasting an advertisement by the television system;
actuating a remote control device of the television system; and
sending an electronic coupon from the digital television system to the mobile device through the communication link,
wherein the electronic coupon including at least one advertising message.

10. The method as recited in claim 9, wherein said method further comprising:
displaying an icon on a display of the mobile device after the electronic coupon is received by the mobile device;
selecting the displayed icon by the user; and
displaying an image of the electronic coupon including at least one advertising message.

11. The method as recited in claim 10, wherein said method further comprising a step of selecting the displayed advertising message to receive next level of details from a data manager connected to the mobile device through a communication network.

12. The method as recited in claim 10, wherein said method further comprising purchasing the advertised product through an on-line facility.

13. The method as recited in claim 9, wherein said operation of “actuating” the remote control device further comprising actuating a dedicated input structure of the remote control device.

14. The method as recited in claim 9, wherein said communication link conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).

15. A method of delivering an advertising message to a mobile communication device comprising:
establishing an ad hoc communication link between a digital television system and the mobile device;
broadcasting an advertisement by the digital television system;
displaying a message in a randomly determined time during broadcasting of the advertisement;
actuating a remote control device of the television system within a predetermined period of time after displaying the message; and
sending an electronic coupon from the digital television system to the mobile device through the communication link,
wherein the electronic coupon including at least one advertising message.

16. The method as recited in claim 15, wherein said method further comprising:
displaying an icon on a display of the mobile device after the electronic coupon is received by the mobile device;
selecting the displayed icon by the user;
displaying an image of the electronic coupon including at least one advertising message.

17. The method as recited in claim 16, wherein said method further comprising a step of selecting the displayed advertising message to receive next level of details from a data manager connected to the mobile device through a communication network.

18. The method as recited in claim 16, wherein said method further comprising purchasing the advertised product through an on-line facility.

19. The method as recited in claim 15, wherein said operation of “actuating” the remote control device further comprising actuating a dedicated input structure of the remote control device.

20. The method as recited in claim 15, wherein said communication link conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).
